(19) United States
(12) Patent Application Publication
(10) Pub. No.: US 2013/0029059 A1
(43) Pub. Date: Jan. 31, 2013

(54) UNIVERSAL OPTICAL FIBER RECOAT APPARATUS AND METHODS

(71) Applicants: Michael E. Harju, Dorr, MI (US); Ying Qin, Holmdel, NJ (US)

(72) Inventors: Michael E. Harju, Dorr, MI (US); Ying Qin, Holmdel, NJ (US)

(21) Appl. No.: 13/360,004

(22) Filed: Jan. 27, 2012

Related U.S. Application Data
(60) Provisional application No. 61/437,033, filed on Jan. 28, 2011.

(51) Int. Cl. B05D 5/06; B05B 3/00

(52) U.S. Cl. 427/510; 118/323; 118/620; 118/100

(57) ABSTRACT

In some embodiments, an apparatus includes a formation member that defines a passageway configured to receive therein at least a portion of an optical fiber that includes a stripped portion to be recoated. The passageway defines at least in part a recoat cross-sectional width of the stripped portion of the optical fiber to be recoated. A nozzle is coupled to the formation member and configured to dispense a recoat material into the passageway when the nozzle is moved relative to the stripped portion of the optical fiber when the stripped portion of the optical fiber is disposed at least partially within the passageway such that the recoat material is dispensed on and surrounds the stripped portion of the optical fiber. In some embodiments, the apparatus includes a controller that can control the flow rate of the recoat material dispensed by the nozzle.

### CROSS-REFERENCE TO RELATED APPLICATIONS

This application claims priority to U.S. Provisional Application No. 61/437,033 filed Jan. 28, 2011, and entitled “UNIVERSAL OPTICAL FIBER RECOAT APPARATUS AND METHODS,” the disclosure of which is hereby incorporated herein by reference in its entirety.

### BACKGROUND

Some embodiments described herein relate generally to methods and apparatus for recoating a stripped region of an optical fiber.

Optical fiber recoat devices and systems can be used to recoat a stripped region or portion of an optical fiber. For example, an optical fiber can be stripped to allow for splicing to another optical fiber. In another example, an optical fiber may be stripped to write a Bragg grating into the optical fiber. Some known optical fiber recoat devices and systems can include precision quartz molds, which can be expensive and limited to use with a single fiber and a single recoat size or diameter. Some known optical fiber recoat systems are limited to use in recoating a stripped portion of an optical fiber having a single size (e.g., diameter) or shape (e.g., circular, square, etc.). Some known optical fiber recoat systems are limited to recoating a stripped portion of an optical fiber such that the optical fiber has a predefined outer diameter or size dictated by the particular dimensions of the recoat system.

Some known optical fiber recoat systems are configured to deliver a predefined amount or volume of recoat material to cover the stripped portion of the optical fiber. For example, in some such optical fiber recoat systems, a stripped portion of an optical fiber is placed in a mold and the mold is injected with a predefined amount or volume of recoat material to cover the stripped portion of the optical fiber. In such systems, because the mold is typically closed around the optical fiber, the recoat material is cured within the confines of the mold after the recoat material has been fully injected into the mold. Such systems can result in bubble formation within the recoat material as it cures due to the constraints within the mold.

Thus, a need exists for improved optical fiber recoat systems and methods that can accommodate multiple different types of recoat materials and/or multiple different sizes of optical fibers and/or are able to achieve multiple different final recoat shapes and sizes of the optical fiber.

### SUMMARY

In some embodiments, an apparatus includes a formation member that defines a passageway configured to receive therein at least a portion of an optical fiber that includes a stripped portion to be recoated. The passageway defines at least in part a recoat cross-sectional width of the stripped portion of the optical fiber to be recoated. A nozzle is coupled to the formation member and configured to dispense a recoat material into the passageway when the nozzle is moved relative to the stripped portion of the optical fiber when the stripped portion of the optical fiber is disposed at least partially within the passageway such that the recoat material is dispensed on and surrounds the stripped portion of the optical fiber. In some embodiments, the apparatus includes a controller that can control the flow rate of the recoat material dispensed by the nozzle.

### BRIEF DESCRIPTION OF THE DRAWINGS

FIG. 1 is a block diagram of an optical fiber recoat apparatus, according to an embodiment.

FIG. 2 is a front perspective view of an optical fiber recoat apparatus, according to an embodiment.

FIG. 3 is a cross-sectional view of a formation member of the optical fiber recoat apparatus of FIG. 2.

FIG. 4 is a cross-sectional view of the formation member of FIG. 3 and a portion of a nozzle of the recoat apparatus of FIG. 2, showing a recoat material disposed within a channel of the formation member.

FIG. 5 is a schematic side view of a fiber recoat apparatus showing the application of an uncured recoat material, according to an embodiment.

FIG. 6 is a schematic side view of the fiber recoat apparatus of FIG. 5 after the application of uncured recoat material within the channel of the formation member of the fiber recoat apparatus.

FIG. 7 is schematic side view of the fiber recoat apparatus of FIG. 5, shown with the recoat material cured.

FIG. 8 is a schematic side view of a fiber recoat apparatus prior to applying uncured recoat material, according to another embodiment.

FIG. 9A is a schematic illustration of an end view of a formation member, shown in an open position; FIG. 9B is an end view of the formation member of FIG. 9A, shown in a closed position; and FIG. 9C is a side view of the formation member of FIG. 9A, shown in the closed position.

FIG. 10 is a schematic side view of the fiber recoat apparatus of FIG. 8 showing the application of an uncured recoat material.

FIG. 11 is a schematic side view of the fiber recoat apparatus of FIG. 8 after the application of the uncured recoat material.

FIG. 12 is a schematic side view of the fiber recoat apparatus of FIG. 8 after the residual uncured recoat material has been spread and cured.

FIG. 13 is a schematic side view of a fiber recoat apparatus according to another embodiment, illustrating a fiber held in a vertical orientation.

FIG. 14 is a schematic illustration of an uncured recoat material distribution system, according to an embodiment.

FIG. 15 is a flowchart illustrating a method of recoating an optical fiber according to an embodiment.

### DETAILED DESCRIPTION

Apparatus and methods are described herein for use in the application of a recoat material to an optical fiber. For example, a recoat material can be applied to a stripped region or portion of an optical fiber. The stripped portion of an optical fiber can include an exposed portion of the optical fiber. For example, an optical fiber can be coated with a variety of different polymer materials, and due to various causes some or all of the coating can be stripped or otherwise removed from some or all of the optical fiber. For example, an optical fiber may be stripped to allow for splicing to another optical fiber. In another example, an optical fiber may be stripped to write a Bragg grating into the fiber.

In some embodiments, an apparatus as described herein can include a nozzle that can dispense uncured recoat material as the nozzle is moved relative to a stripped region of an optical fiber. The nozzle can be coupled, for example, to a movable carriage of the fiber recoat apparatus. In some embodiments, the fiber recoat apparatus can include an uncured recoat material distribution system that can deliver uncured recoat material to the nozzle at a controlled flow rate. The fiber recoat apparatus can include a formation member that defines a formation passageway in or through which an optical fiber can be disposed. In some embodiments, the formation passageway is in the form of a channel having an elongate open portion through which an optical fiber can be received. In some embodiments, the formation passageway can include an opening on opposite ends of the formation passageway such that an optical fiber can be received therethrough. In some embodiments, a formation member can be coupled to a movable carriage such that the formation member moves with the carriage relative to the optical fiber to apply a recoat material to the optical fiber.

In some embodiments, the formation member can encircle or surround the stripped region of an optical fiber during a recoating process. In some embodiments, the formation member encircles or surrounds only a portion of the stripped region of the optical fiber. In some embodiments, a fiber recoat apparatus as described herein can include one or more lights sources that can be used to cure the recoat material after being dispensed onto and around the stripped region of the optical fiber.

In some embodiments, a fiber recoat apparatus can be configured to recoat optical fibers having different cross-sectional shapes and/or sizes and can achieve multiple different recoat cross-sectional shapes and/or sizes. For example, in some embodiments, the fiber recoat apparatus can recoat a stripped portion of the optical fiber such that it has a desired recoat cross-sectional width. The fiber recoat apparatus can be configured to use multiple different removable formation members each of which has different sized and/or shaped formation passageways (e.g., having different cross-sectional shapes and/or sizes). In some embodiments, a fiber recoat apparatus can be configured to apply multiple different types of recoat material. For example, it may be desirable to apply a first layer of a first type of recoat material and a second layer of a second type of recoat material over the first layer. In another example, it may be desirable to recoat a first portion of an optical fiber with a first type of recoat material and a second portion of the optical fiber with a second type of recoat material.

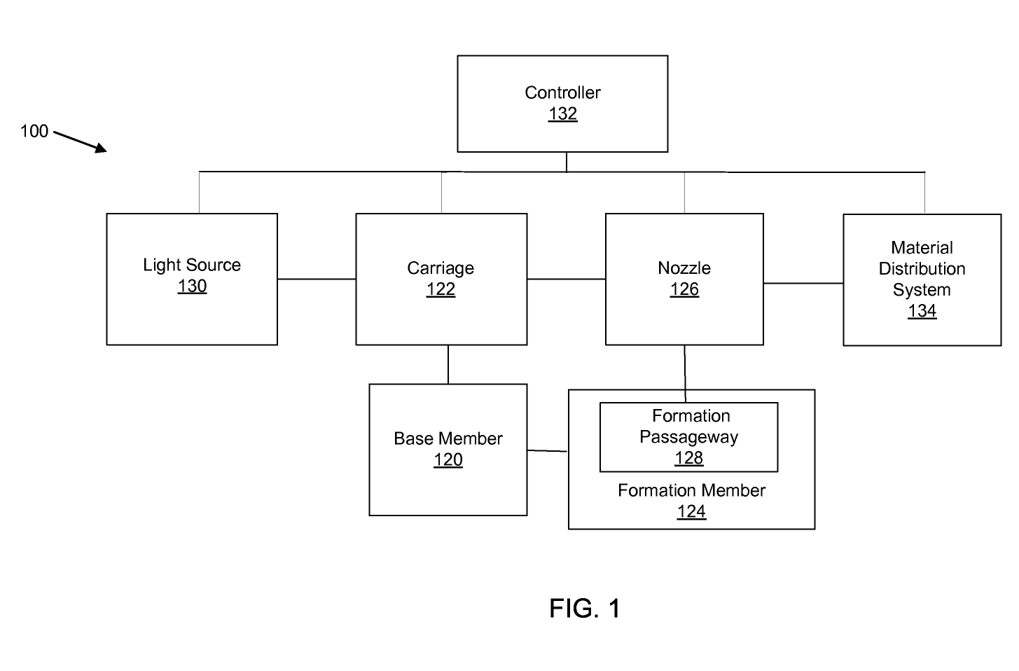

FIG. 1 is a schematic illustration of an optical fiber recoat apparatus according to an embodiment. An optical fiber recoat apparatus 100 (also referred to as “fiber recoat apparatus” and “recoat apparatus”) includes a base member 120, a carriage 122, a formation member 124, one or more nozzles 126, one or more light sources 130, a controller 132 and a material distribution system 134. The recoat apparatus 100 is configured to receive and couple thereto an optical fiber (not shown in FIG. 1) having a stripped portion to be recoated. For example, the optical fiber can include a stripped region or portion where the coating or outer layer of the fiber has been removed exposing a portion of the underlying optical fiber (e.g., glass fiber portion). In some embodiments, the optical fiber can include a stripped region or portion where a layer of an outer coating has been removed exposing an intermediate layer of coating between the outer layer and the underlying glass fiber. The recoat apparatus 100 can be used to recoat the stripped portion of the optical fiber. In some embodiments, the coating from an optical fiber may have been removed as a result of a previously completed splicing operation, which joined the opposing fiber sides or ends. In some embodiments, the coating may have been removed as a result of forming a fiber Bragg grating in the stripped fiber region.

The formation member 124 can be used to form a desired cross-sectional shape and/or size of a stripped portion of an optical fiber. For example, the formation member 124 can define a formation passageway 128 that has a predetermined cross-sectional shape and/or size. The formation passageway 128 can define, for example, a cross-sectional width and/or height and/or shape. The cross-sectional shape can be, for example, circular, square, rectangular, elliptical, diamond shaped, or any other desired shape. The cross-sectional width and/or height can be for example, a diameter or a linear dimension such as a length or width of a rectangle or square cross-sectional shape. The formation passageway 128 can also have various lengths and can be linear or straight, or curved, or can include both a linear portion and a curved portion. In some embodiments, a single formation member 124 can accommodate different sized optical fibers (e.g., different cross-sectional diameter, width, height, etc.) and/or accommodate different recoat sizes (e.g., different cross-sectional diameter, width, height, etc.). Although not shown in FIG. 1, the recoat apparatus 100 can also include multiple formation members 124 that can be selectively coupled to the recoat apparatus 100.

The recoat apparatus 100 can also optionally include one or more inserts (not shown in FIG. 1) that can be coupled to a formation member 124. For a set of inserts each can include a formation passageway having a size to accommodate a size of optical fiber different from the sizes of the formation passageway for the remaining inserts. In some embodiments, each insert can be, for example, slidably received within the formation member 124 to at least partially define the formation passageway 128. In some embodiments, each insert can be, for example, coupled to the formation member 124 with a coupling member, such as a clamp, a bracket, or other known coupling mechanism. In some embodiments, the formation member 124 can include multiple formation passageways 128 to accommodate recoating multiple optical fibers at the same time or at different times. For example, a first optical fiber can be recoated within a first formation passageway 128 of the formation member 124 simultaneously with a second optical fiber being recoated within a second formation passageway 128 of the formation member 124. In some embodiments, a first optical fiber can be recoated within a first formation passageway 128 of the formation member 124 and then a second optical fiber can be recoated within a second formation passageway 128 of the formation member 124 after the first optical fiber has been recoated. In such an embodiment, the multiple formation passageways 128 can each be the same cross-sectional size and/or shape, or can each be sized and/or shaped to accommodate a different size and/or shape of optical fiber. In some such embodiments, inserts can optionally be used to accommodate different sizes and/or shapes as described above.

The optical fiber to be recoated can be coupled to the recoat apparatus 100 in a variety of different manners depending on the particular implementation of the recoat apparatus 100. In some implementations, a first end portion of the optical fiber and a second end portion of the optical fiber can each be coupled to the fiber recoat apparatus 100 with fiber holders (not shown in FIG. 1). The fiber holders can include adjustable fiber holder inserts to accommodate different optical fibers having different sizes (e.g., diameters) and/or shapes. The fiber holders can provide tension to a given optical fiber to maintain the optical fiber in a desired position or arrangement (e.g., straight or curved) during the recoating process.

The carriage 122 can be coupled to the base member 120 and move relative to an optical fiber coupled to the recoat apparatus 100. For example, the carriage 122 can move or translate along a length or a portion of a length of an optical fiber coupled to the recoat apparatus 100. The nozzle(s) 126 and the light source(s) 130 can each be coupled to the carriage 122 such that the nozzle(s) 126 and the light source(s) 130 also can move with the carriage 122 relative to the optical fiber. In some embodiments, the nozzle(s) 126 can be defined by the formation member 124. For example, in such an embodiment, the formation member 124 can be coupled to the carriage 122 such that the nozzle 126 can move with the carriage 122 relative to an optical fiber. The nozzle(s) 126 can define a lumen (not shown in FIG. 1) that has, for example, an inner diameter in the range of 0.020 inch to 0.060 inch. The diameter of the lumen of the nozzle(s) 126 can be greater or smaller than this range. The nozzle(s) 126 also define a dispensing opening in fluid communication (e.g., a fluid, such as a gas or a liquid can pass therebetween) with the lumen and in fluid communication with the formation passageway 128 (e.g., a fluid, such as, a gas or a liquid, can pass between the dispensing opening and the lumen and between the dispensing opening and the formation passageway 128).

In some embodiments, the nozzle(s) 126 can include a spring-loaded trap door or other closing mechanism or valve that can be used to cover the dispensing opening of the nozzle(s) 126 and prevent or limit recoat material from dripping out of the nozzle(s) 126 after the recoat process is completed. In some embodiments, uncured recoat material can remain in the nozzle(s) 126 and can be used during a subsequent recoat process to recoat another optical fiber. For example, with the nozzle(s) 126 already filled with recoat material, the process time of filling the nozzle(s) 126 at the start of another recoat operation can be reduced. In some embodiments, the formation member 124 is also coupled to the carriage 122 such that the formation member 124 can move relative to the optical fiber. Details of such an embodiment are described below.

In some embodiments, the formation member 124 defines a formation passageway 128 that includes an elongated channel having an elongated opening along a portion of the channel in which the stripped portion of an optical fiber can be received. The channel can be a variety of different shapes and/or sizes. For example, the channel can have a cross-sectional shape that is u-shaped, v-shaped, a semicircle, a rectangle, a portion of a circle, parabola or ellipse, or any other suitable shape. In such an embodiment in which the formation passageway 128 is in the form of a channel, a stripped portion of an optical fiber can be coupled to the formation member 124 and within the formation passageway 128 such that the stripped portion of the optical fiber is disposed offset from a bottom surface of the formation passageway 128. The carriage 122 can then be moved relative to the formation member 124 (e.g., the channel) and the optical fiber disposed within the formation passageway 128. For example, the carriage 122 can be moved in a direction substantially parallel to a centerline of the formation passageway 128 such that the carriage 122 translates along a length or portion of a length of the optical fiber. As the carriage 122 is moved relative to the formation member 124 and the optical fiber, an uncured recoat material can be dispensed into the formation passageway 128 via the nozzle(s) 126 and into the elongated opening of the formation passageway 128.

As the recoat material is dispensed into the formation passageway 128, the recoat material can flow around and be disposed onto and surround the stripped portion of the optical fiber. The recoat material can be dispensed such that it fills, substantially fills or partially fills the formation passageway 128 (e.g., channel). In some embodiments, the formation member 124 can help confine the uncured recoat material around the stripped portion of the optical fiber. In some embodiments, the formation member 124 confines or bounds a portion of the recoat material, but does not confine or bound a second portion of the recoat material within the formation passageway 128. For example, a portion of the recoat material dispensed into the formation passageway 128 near or at the elongate opening of the formation member 124 can be unbounded allowing the recoat material to be free to shrink or form a desired shape. The shape of the free surface of the uncured recoat material can be controlled, at least partially by various factors, such as, for example, the viscosity of the uncured recoat material, the flow rate from the nozzle 126, the shape of the formation passageway 128 and/or the translation velocity of the nozzle 126 along the length of the formation passageway 128 (e.g., channel). In some embodiments, the free surface of the recoat material within the formation passageway 128 can be substantially flat. In some embodiments, the uncured recoat material can be a thick, high viscosity material (e.g., a high viscosity liquid), and the free surface can have a bowed or curved surface, rather than a flat surface. In some embodiments, the flow rate can be controlled such that the uncured recoat material does not overflow the formation passageway 128 (e.g., channel).

In some embodiments, rather than the formation member 124 defining a passageway in the form of a channel and having an elongate opening along the channel, the formation member 124 defines a formation passageway 128 that has a first opening or aperture on one end and a second opening or aperture on an opposite end such that at least a portion of an optical fiber to be recoated can be received therethrough. In such embodiments, the formation member 124 can be, for example, coupled to the moveable carriage 122 such that the formation member 124 can be moved relative to an optical fiber to be recoated. In some other such embodiments, the formation passageway 128 can be tapered or include a tapered portion. In some such embodiments, the formation passageway 128 has a substantially constant shape and/or size. As described above, as the carriage 122 can move relative to an optical fiber to be recoated, the nozzle(s) 126 can dispense an uncured recoat material into the formation passageway 128 such that the recoat material is disposed onto and surrounds at least a portion of the stripped portion of the optical fiber.

After the recoat material has been dispensed into the formation passageway 128, the light source(s) 130 can be used to cure the uncured recoat material. As described above, the light source(s) 130 can be coupled to the carriage 122 such that as the carriage 122 is moved relative to the optical fiber, and the recoat material is dispensed into the formation passageway 128, the light source(s) 130 can incrementally cure the recoat material within the formation passageway 128 as the carriage 122 translates along a length of the optical fiber. In some embodiments, the uncured recoat material may not reach an equilibrium distribution, but instead can be cured while still settling in the formation passageway 128.

In some embodiments, the light source(s) 130 can be disposed on a separate movable light carriage (not shown). In such an embodiment, after the uncured recoat material has been dispensed into the formation passageway 128 and the dispensing process is complete, the light carriage with the light source(s) 130 can be moved to a position in which the light source(s) 130 is disposed near or over the recoated optical fiber.

As previously described, the uncured recoat material can have a free surface where the uncured recoat material is not constrained during the curing process, which can help to reduce bubble formation during the cure process. The light source(s) 130 can emit electromagnetic radiation that reacts with the uncured recoat material to cure the recoat material. The light source(s) 130 can, for example, emit ultraviolet (UV) radiation. In some embodiments, the light source(s) 130 can include multiple UV light emitting diodes (LEDs). In such an embodiment, the UV LEDs can be surface mounted devices. In some embodiments, the multiple UV LEDs can be mounted on a common circuit board. The UV LEDs can emit a wavelength, for example, in the range of 350 to 400 nm. The UV LEDs can be, for example, a model NCSUO33A(T) available from Nichia Inc., TOKUSHIMA, Japan. In some embodiments, UV LEDs can be more efficient than alternative electromagnetic radiation sources and thus generate less waste heat. Waste heat from the light source(s) 130 can be undesirable because the waste heat can interfere with the flow of the uncured recoat material in the nozzle(s) 126. Gas based UV lamps can generate significant undesirable waste heat potentially interfering with the flow of recoat material, but the waste heat from the UV LEDs can be negligible.

After curing the recoat material, the stripped portion of the optical fiber will be covered with cured recoat material and the optical fiber may be removed from the recoat apparatus. In some embodiments, the entire recoating process, both dispensing and curing the recoat material, can be completed in, for example, 1 to 2 minutes; however, faster or slower times are possible.

The controller 132 can be used to control a flow rate of the uncured recoat material dispensed by the nozzle(s) 126 into the formation passageway 128. For example, the controller 132 can be used to control the flow rate and/or duration that the uncured recoat material is dispensed into the formation passageway 128. In some embodiments, the controller 132 can be used to prevent the uncured recoat material from overflowing the formation passageway 128. For example, the controller 132 can include a database pre-loaded with values, such as a flow rate and a duration of flow, appropriate for a given size and shape of formation passageway 128. The controller 132 can include, for example, a computing device having one or more processors, and computer code thereon for performing various computer-implemented operations. In some embodiments, the controller 132 can be used to control other functions of the recoat apparatus 100, such as, for example, operation of the carriage 122. In some embodiments, a separate controller (not shown in FIG. 1) can be used to control other functions of the recoat apparatus 100.

The material distribution system 134 can be included with the fiber recoat apparatus 100 or coupled to the fiber recoat apparatus 100. For example, the material distribution system 134 can be coupled to the nozzle 126(s) and can include a supply of an uncured recoat material. Thus, in some embodiments, the uncured recoat material can be stored in a recoat material reservoir of the material distribution system 134 and delivered to the nozzle 126.

The formation member 124 can be fabricated from a wide range of materials including, for example, stainless steel, tool steel, and Teflon®, or other suitable materials may be used. The formation member 124 can be fabricated with, for example, a material that is substantially opaque to light that is emitted from the light source(s) 130. In some embodiments, the formation member 124 can be formed with a material that is transparent to ultraviolet light. The formation member 124 can optionally be coated with a non-stick agent, which can prevent, at least partially, the recoat material from adhering to the formation member 124. For example, at least a portion of the formation member 124 that bounds the formation passageway 128 can be coated. An example of a suitable coating material is a dispersed Teflon® film.

The fiber recoat apparatus 100 can be used to apply a variety of different types of recoat materials used for covering an optical fiber. For example, a fiber recoat material can include, UV curable polymer #950-200 available from DSM Desotech Inc., Elgin I, or UV curable polymer #PC-373 available from Luvantix Inc. of Gyeonggi-do, South Korea. These materials are merely examples, as other optically curable recoat materials may alternatively be used.

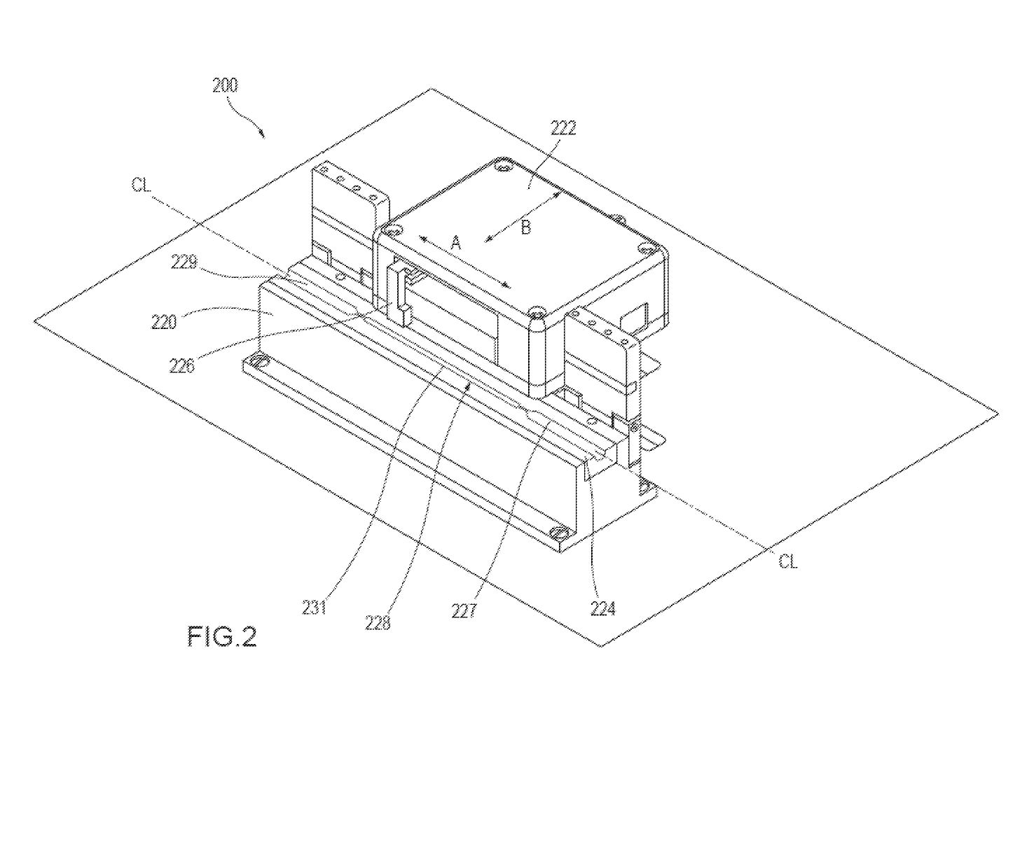

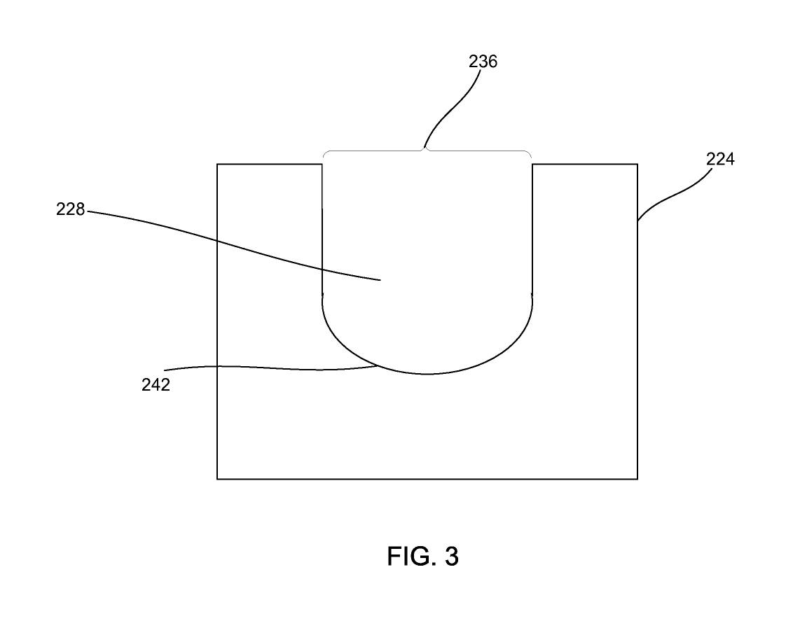

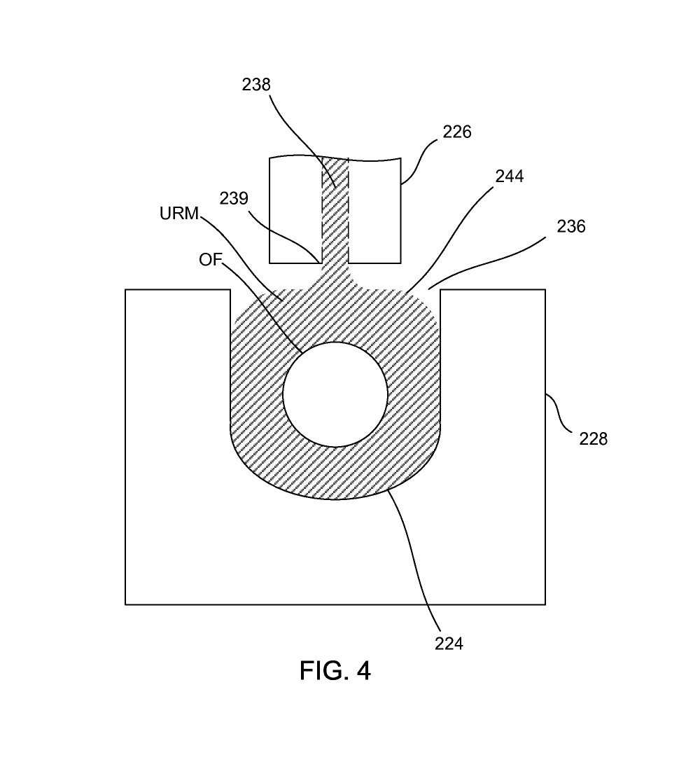

FIGS. 2-4 illustrate a fiber recoat apparatus according to an embodiment. A fiber recoat apparatus 200 includes a base member 220, a carriage 222, a formation member 224 defining a formation passageway 228, a nozzle 226 and a light source (not shown in FIGS. 2-4). In this embodiment, the formation passageway 228 is in the form of a channel in which an optical fiber OF (see e.g., FIG. 4) having a stripped portion can be disposed. The formation passageway 228 includes a first end portion 227 and a second end portion 229 on opposite end portions of the formation member 224, and a middle portion 231 between the first end portion 227 and the second end portion 229. An elongate opening 236 is defined along a length of the formation member 224 that is in fluid communication with the formation passageway 228. A first portion of the optical fiber OF can be placed in the first end portion 227 and a second portion of the optical fiber OF can be placed in the second end portion 229 such that a stripped portion of the optical fiber OF can be disposed within the middle portion 231 of the formation passageway 228 and suspended at a non-zero distance from a bottom surface 242 of the formation passageway 228.

The formation member 224 can be formed with the same materials as described above for FIG. 1 and can be selectively coupled to the recoat apparatus 200. For example, although one formation member 224 is illustrated, the recoat apparatus 200 can include multiple selectable and interchangeable formation members 224 each having a different cross-sectional size and/or shape as described above for FIG. 1. In addition, although the formation member 224 includes a formation passageway 228 with a cross-sectional u-shape, other shapes can alternatively be used as previously described.

The carriage 222 can move in a first direction A and a second direction B (as shown in FIG. 2) relative to the formation passageway 228, and relative to an optical fiber OF disposed therein. For example, the carriage 222 can move or translate in the direction A substantially parallel to a centerline CL (see FIG. 2) defined by the formation passageway 228 to dispense an uncured recoat material into the formation passageway 228 and onto the stripped portion of the optical fiber OF. The carriage 222 can also move in the direction B substantially perpendicular to the centerline CL of the formation passageway 228 and substantially perpendicular to the direction A. For example, the carriage 222 can move in the direction B between a first position in which the carriage 222 is disposed to provide access to a user to place the optical fiber OF into the formation passageway 228, and to a second position in which the carriage 222 is disposed at least partially above the formation passageway 228. When in its second position, the carriage 222 can move or traverse in the direction A along a length or portion of a length of the optical fiber OF such that a recoat material can be dispensed into the formation passageway 228 and distributed along at least a portion of a length of the optical fiber OF.

The nozzle 226 is coupled to the carriage 222 such that the nozzle 226 can move with the carriage 222 relative to the formation passageway 228 and relative to the optical fiber OF. During use in a recoat operation, an uncured recoat material URM (see, e.g., FIG. 4) can be supplied to the nozzle 226. For example, the recoat apparatus 200 can include or be coupled to a uncured recoat material distribution system (not shown) that can be coupled to the nozzle 226 with, for example, a supply hose or tube (not shown). The nozzle 226 defines a lumen 238 in fluid communication with an opening 239 (see, e.g., FIG. 4) through which the recoat material can be dispensed into the formation passageway 228. When the carriage 222 is in its second position, the opening 239 of the nozzle 226 is disposed over a portion of the elongate opening 236 of the formation member 224 such that during a recoat process, the nozzle 226 can dispense the uncured recoat material URM through the elongate opening 236 and into the formation passageway 228 as shown, for example, in FIG. 4. As described above, the opening 239 of the nozzle 226 can include a spring-loaded trap door (not shown) or other closing valve or mechanism to close the opening 239 of the nozzle 226 and prevent recoat material from dripping out of the nozzle 226 after the dispensing process has been completed.

The recoat apparatus 200 can also include a controller (not shown) that can control the flow rate and duration of dispensing the uncured recoat material URM. For example, the flow rate can be controlled such that a sufficient amount of the uncured recoat material URM can be dispensed into the formation passageway 228 as the carriage 222 travels along the length of the optical fiber OF to substantially cover the stripped portion of the optical fiber OF, but does not overflow the formation passageway 228.

In this embodiment, when disposed in the formation passageway 228, the uncured recoat material URM is bounded by a first portion of the formation member 224, and unbounded or free on a second portion 244 at or near the elongate opening 236, as shown in FIG. 4. The free second portion 244 of the uncured recoat material URM can allow the uncured recoat material URM to shrink and/or change shape as it cures within the formation passageway 228, and can reduce, at least partially, bubble formations that can otherwise result when the uncured recoat material URM is constrained.

The light source (not shown in FIGS. 2-4) can be coupled to an underside of the carriage 222 and can move with the carriage 222 as described above for recoat apparatus 100. The light source can include one or more light sources as described above. As with the nozzle 226, the light source can be positioned over the elongate opening 236 of the formation member 224 when the carriage is in its second position. As the carriage 222 moves or translates along a length of the optical fiber OF, the light source can emit a light to cure the uncured recoat material URM after it has been dispensed within the formation passageway 228. For example, as described above, the light source can expose the uncured recoat material URM to, for example, UV light, through the elongate opening 236. When the curing process is complete, the optical fiber OF can be removed from the recoat apparatus 200, for example, by a user or with an automated mechanism (not shown).

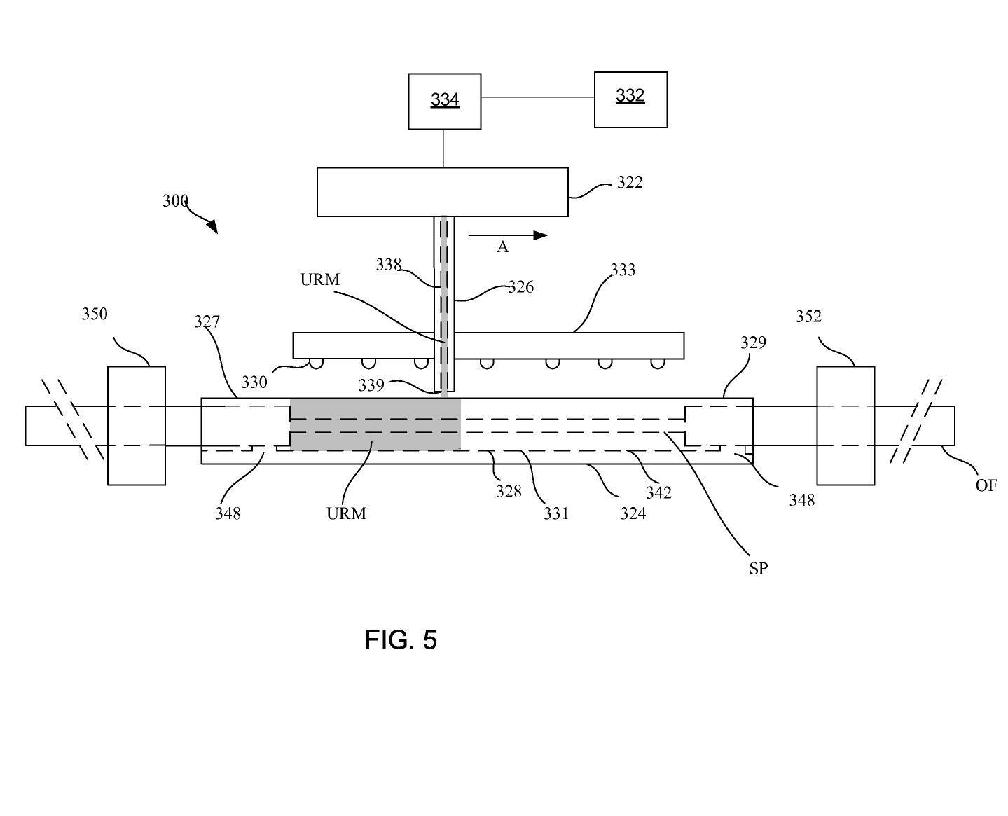

FIGS. 5-7 illustrate an embodiment of a recoat apparatus during a process of recoating a stripped portion of an optical fiber disposed within a formation passageway of the recoat apparatus. In this embodiment, a recoat apparatus 300 includes a carriage 322 movably coupled to a base member (not shown), a formation member 324 defining a formation passageway 328, a nozzle 326 and multiple light sources 330. As with the previous embodiments described in correlation with FIGS. 1-4, the formation passageway 328 is in the form of a channel in which an optical fiber OF having a stripped portion SP can be disposed, as shown in FIGS. 5-7.

The formation passageway 328 includes a first end portion 327 and a second end portion 329 on opposite end portions of the formation member 324, and a middle portion 331 between the first end portion 327 and the second end portion 329. The formation member 324 also defines an elongate opening (not shown) along a length of the formation member 324 that is in fluid communication with the formation passageway 328. The formation passageway 328 defines a recoat cross-sectional size and/or shape of the optical fiber to be recoated. For example, the formation passageway 328 can define at least a portion of a recoat diameter and/or a recoat width and/or height. In this embodiment, the formation member 324 also includes raised steps or protrusions 348 in each of the first end portion 327 and the second end portion 329. The steps 348 can help confine uncured recoat material in the formation passageway 328. For example, the steps 348 can prevent or limit uncured recoat material from flowing between the portions of the optical fiber OF that are not stripped and out an end of the formation passageway 328.

A first portion of the optical fiber OF that is not stripped can be coupled to the recoat apparatus 300 with a fiber holder 350, and a second portion of the optical fiber OF that is not stripped can be coupled to the recoat apparatus 300 with a fiber holder 352. The fiber holders 350 and 352 can each couple the optical fiber OF to, for example, the base member (not shown) of the recoat apparatus 300. In some embodiments, the fiber holders 350 and 352 can each couple the optical fiber OF to the formation member 324. The fiber holders 350 and 352 can each be, for example, a holding block, a clamp, or other suitable holding mechanism. The fiber holders 350 and 352 can provide tension to the optical fiber OF to help maintain the optical fiber OF, for example, substantially straight or aligned in the formation passageway 328. The fiber holders 350 and 352 can also optionally include adjustable inserts (not shown in FIGS. 5-7) as described above to accommodate different sizes and/or shapes of optical fibers. When the optical fiber OF is coupled to the recoat apparatus 300, the stripped portion SP of the optical fiber OF can be disposed within the middle portion 331 of the formation passageway 328 and suspended at a non-zero distance from a bottom surface 342 of the formation passageway 328.

The formation member 324 can be formed with the same materials as described above for previous embodiments and can be selectively coupled to the recoat apparatus 300. For example, although one formation member 324 is illustrated, the recoat apparatus 300 can include multiple selectable and interchangeable formation members 324 each having a formation passageway with a different cross-sectional size and/or shape as described above for previous embodiments.

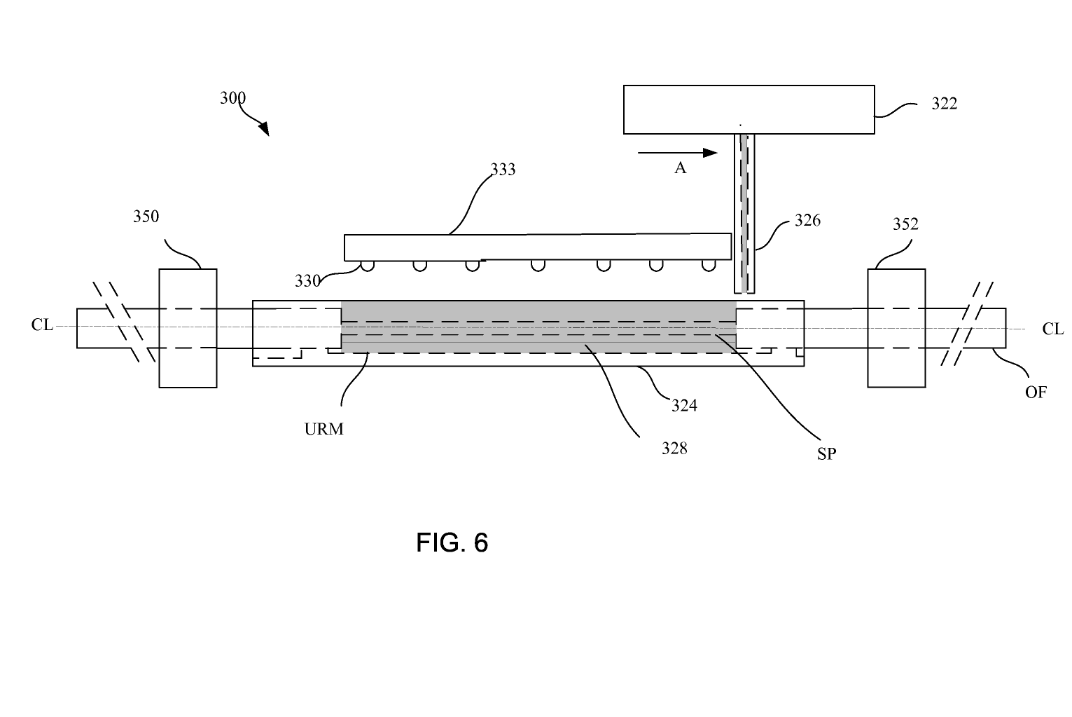

The carriage 322 can move in a first direction A (see, e.g., FIG. 5) substantially parallel to the formation passageway 328, and a second direction (not shown) substantially perpendicular to the formation passageway 328. For example, the carriage 322 can move or translate in the direction A substantially parallel to a centerline CL defined by the formation passageway 328 (see e.g., FIG. 6) to dispense an uncured recoat material URM into the formation passageway 328 and onto the stripped portion SP of the optical fiber OF. The carriage 322 can also move in a direction substantially perpendicular to the centerline CL of the formation passageway 328 as described above for carriage 222. Thus, the carriage 322 can move between a first position in which the carriage 322 is disposed to provide access to a user to place the optical fiber OF into the formation passageway 328 (e.g., at a distance perpendicular from the centerline CL of the formation passageway), and to a second position in which the carriage 322 is disposed at least partially above the formation passageway 328. When in its second position, the carriage 322 can move or traverse in the direction A along a length or portion of a length of the optical fiber OF such that the uncured recoat material URM can be dispensed into the formation passageway 328 and distributed along at least a portion of the length of the optical fiber OF.

The nozzle 326 is coupled to the carriage 322 such that the nozzle 326 can move with the carriage 322 relative to the formation passageway 328 and relative to the optical fiber OF disposed therein. An uncured recoat material URM can be supplied to the nozzle 326 from a material distribution system 334. The nozzle 326 defines a lumen 338 in fluid communication with an opening 339 through which the uncured recoat material URM can be dispensed into the formation passageway 328. The flow of the uncured recoat material URM can be controlled with a controller 332 during the recoat process, as described above for previous embodiments. For example, the flow rate can be controlled such that the uncured recoat material URM does not overflow the formation passageway 328. As described above, and as shown in FIGS. 5 and 6, when the carriage 322 is moved along a length of the optical fiber OF, the nozzle 326 can dispense the uncured recoat material URM through the elongate opening of the formation member 324 and into the formation passageway 328. FIG. 6 illustrates the carriage 322 at the end of its travel in the direction A, and the formation passageway 328 filled, or substantially filled, with the uncured recoat material URM. As described above, the nozzle 326 can also include a closing mechanism (not shown) that can be used to cover the opening 339 when the dispensing process is complete.

As with the previous embodiment, when disposed in the formation passageway 328, the uncured recoat material URM is bounded by a first portion of the formation member 324, and unbounded or free on a second portion at or near the elongate opening of the formation member 324. The free second portion of the uncured recoat material URM can allow the uncured recoat material URM to shrink and/or change shape as it cures within the formation passageway 328 and can reduce, at least partially, bubble formations that can otherwise result within the recoat material.

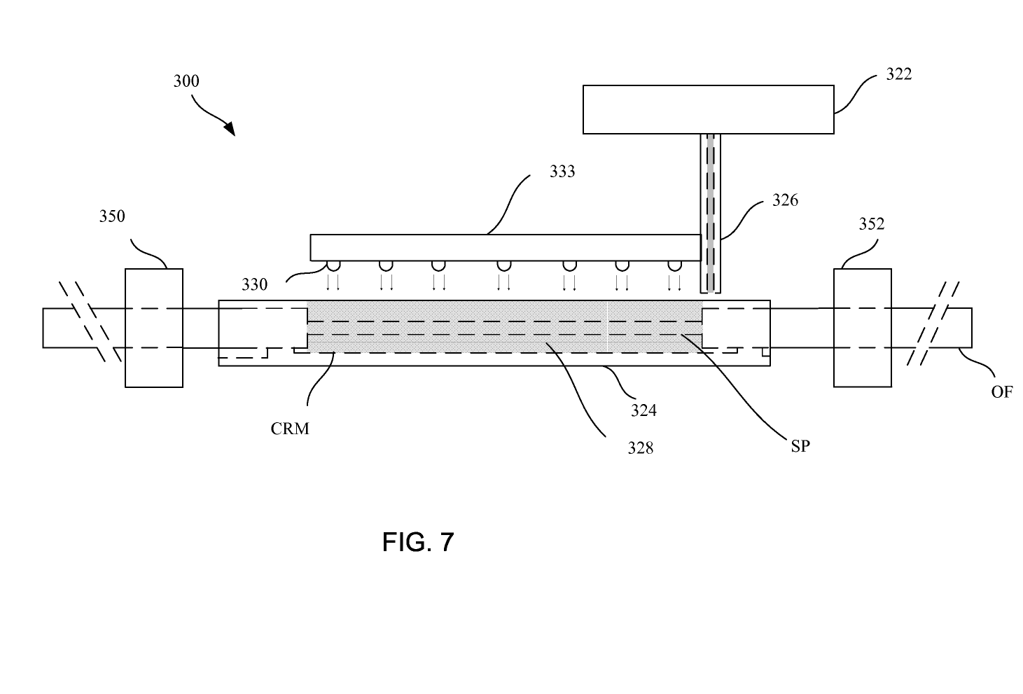

In this embodiment, the light sources 330 are coupled to a light carriage 333 and can move in a direction perpendicular to the direction A and to the formation passageway 328. The light carriage 333 can be moved from a first position in which the light sources 328 are disposed at a distance from the formation passageway 324 in a direction perpendicular to the formation passageway 328, and a second position in which the light sources 330 are positioned near or over the elongate opening of the formation member 324. The light carriage 333 can be moved to its first position during the dispensing process, and after the uncured recoat material URM has been dispensed into the formation passageway 328 and the dispensing process is complete, the light carriage 333 can be moved to its second position such that the light sources 330 are disposed near or over the elongate opening of the formation member 324. As described above the light sources 330 can expose the uncured recoat material URM to, for example, UV light through the elongate opening of the formation member 324, as shown in FIG. 7. After the curing process is complete, the stripped portion SP of the optical fiber OF will be coated with cured recoat material CRM, as shown in FIG. 7, and the recoated optical fiber can be removed from the recoat apparatus 300. In alternative embodiments, the light sources 330 can be coupled to and moveable with the carriage 322 in a similar manner as described above for recoat apparatus 200.

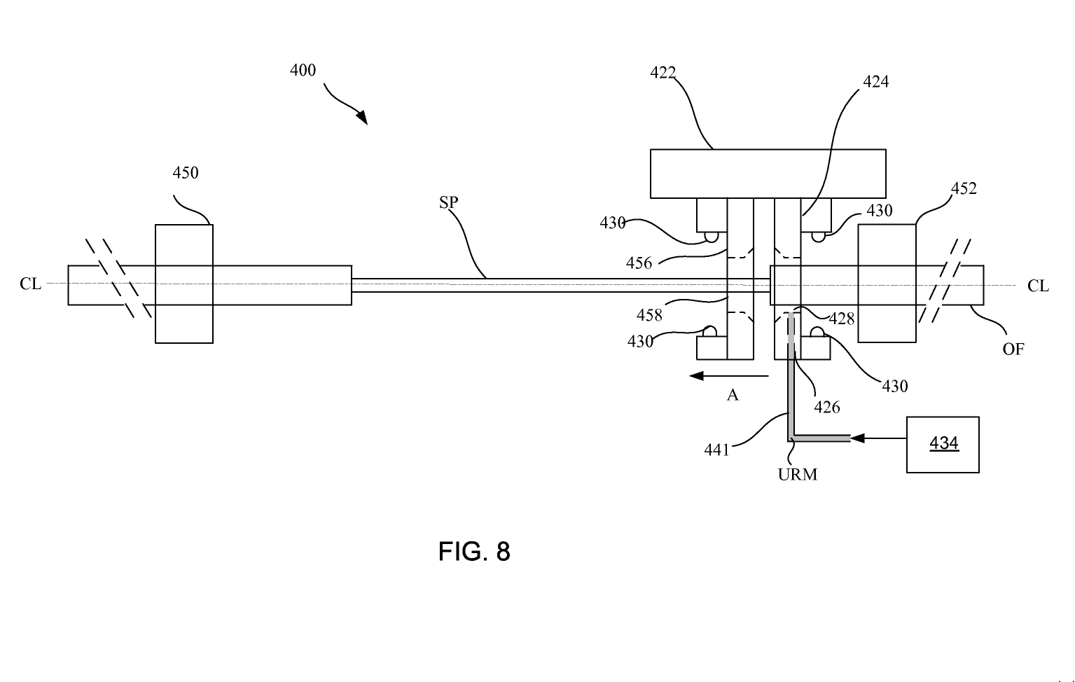

FIGS. 8-12 illustrate another embodiment of a recoat apparatus. The recoat apparatus 400 includes a carriage 422, a formation member 424 defining a formation passageway 428, a nozzle 426 and light sources 430. The recoat apparatus 400 also includes a spreader member 456 that defines a spreader passageway 458. In this embodiment, the formation member 424 and the spreader member 456 are each coupled to the carriage 422 such that they can move with the carriage 422 relative to an optical fiber OF as described in more detail below.

A first portion of the optical fiber OF that is not stripped can be coupled to the recoat apparatus 400 with a fiber holder 450, and a second portion of the optical fiber OF that is not stripped can be coupled to the recoat apparatus 400 with a fiber holder 452. The fiber holders 450 and 452 can each couple the optical fiber OF to, for example, a base member (not shown) of the recoat apparatus 400. The fiber holders 450 and 452 can each be configured the same as or similar to, and function the same as or similar to, the fiber holders described above for previous embodiments. For example, the fiber holders 450 and 452 can optionally include adjustable inserts (not shown in FIGS. 8-12) as described above to accommodate different sizes and/or shapes of optical fibers.

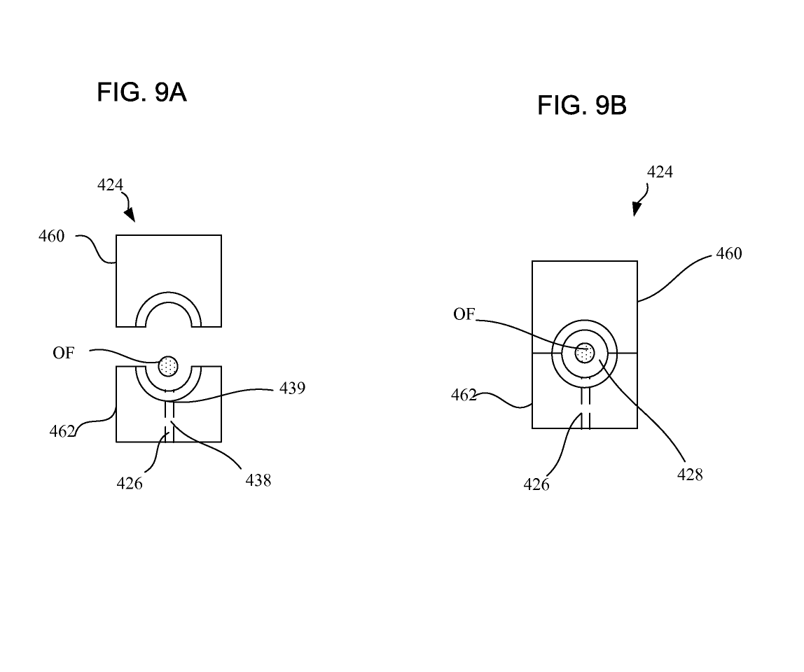

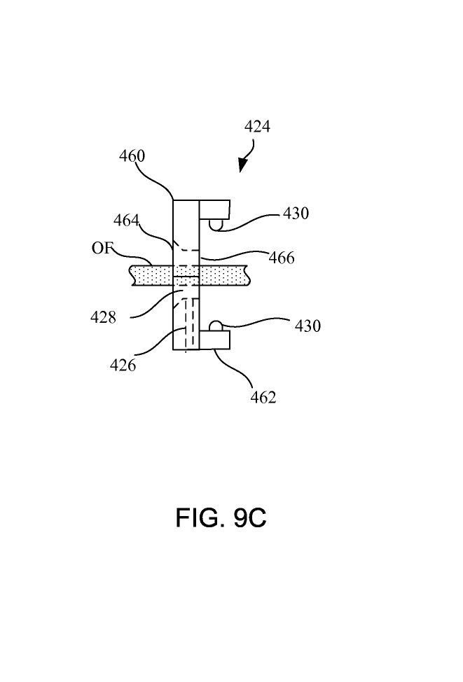

In this embodiment, as shown for example, in FIGS. 9A-9B, the formation member 424 includes a first portion 460 and a second portion 462 that collectively define the formation passageway 428 when coupled together as shown in FIGS. 9B and 9C. The first portion 460 and the second portion 462 also collectively define a first opening 464 and a second opening 466 each in fluid communication with the formation passageway 428 when the first portion 460 and the second portion 462 are coupled together (see, e.g., FIG. 9C). The first portion 460 and the second portion 462 can be coupled together with, for example, a hinge, a clamp, a screw or other suitable coupling mechanism (not shown). In alternative embodiments, the formation member 424 can be formed as a single component. In other words, the first portion 460 and the second portion 464 can be formed monolithically.

The formation passageway 428 can be tapered or have a tapered portion (as shown in FIGS. 8, 10, 9C, 11 and 12), or have a constant cross-sectional shape and/or size. For example, in this embodiment, the first opening 464 is larger (e.g., has a greater diameter) than the second opening 466. In some embodiments, the first opening 464 can be smaller than the second opening 466. The formation passageway 428 defines a recoat cross-sectional size and/or shape of the optical fiber to be recoated. For example, the formation passageway 428 can define at least a portion of a recoat diameter and/or a recoat width and/or height. The nozzle 426 is defined by the formation member 424 and is in fluid communication with the formation passageway 428. The nozzle 426 defines a lumen 438 in fluid communication with an opening 439, and can include a closure mechanism (not shown) for closing the opening 439 as described above for previous embodiments. In this embodiment, the nozzle 426 is disposed on the second portion 462, but it should be understood that in alternative embodiments, the nozzle 426 can be disposed on the first portion 460.

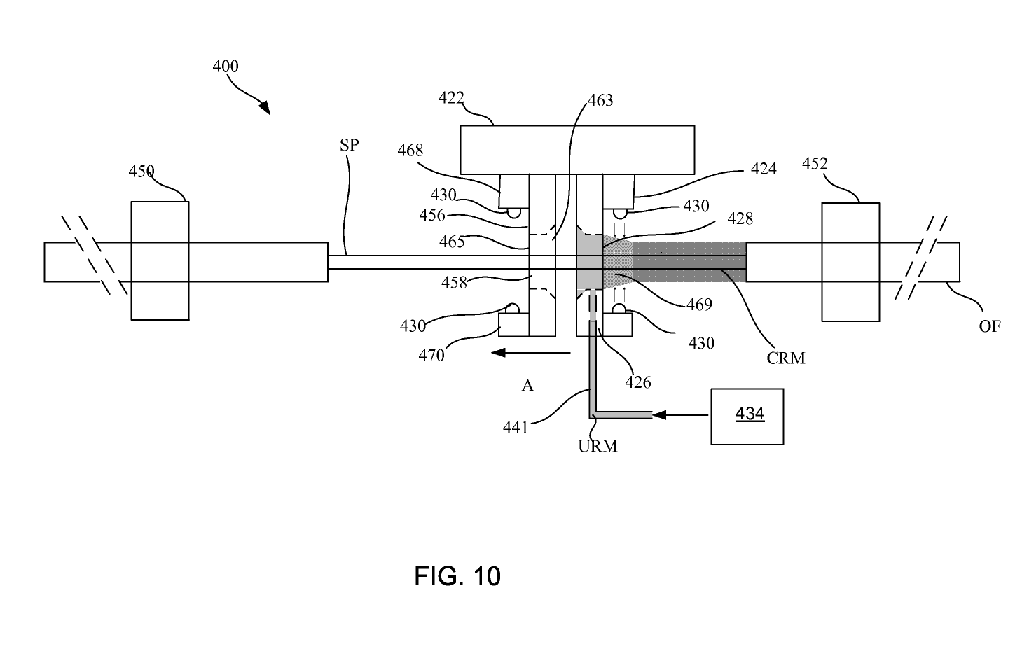

The spreader member 456 can be similarly constructed as the formation member 424 and include a first portion 468 and a second portion 470 (see, e.g., FIG. 10) that collectively define the spreader passageway 458 when coupled together. The first portion 468 and the second portion 470 also collectively define a first opening 463 and a second opening 465 each in fluid communication with the spreader passageway 458 when the first portion 468 and the second portion 470 are coupled together (as shown, for example, in FIG. 10). The spreader passageway 458 defines at least in part a recoat cross-sectional size and/or shape, such as a recoat cross-sectional diameter and/or width and and/or height. The spreader passageway 458 can be tapered or have a tapered portion (as shown in FIGS. 8, 10, 9C, 11 and 12) or have a constant cross-sectional shape and/or size. For example, in this embodiment, the first opening 463 is larger (e.g., has a greater diameter) than the second opening 465. In some embodiments, the first opening 463 can be smaller than the second opening 465. The spreader passageway 458 can be the same size and shape as the passageway 424, or can have a different size and shape. In some embodiments, the spreader passageway 458 can be tapered in an opposite direction as the taper of the formation passageway 428. In some embodiments, the spreader passageway 458 and the formation passageway 424 can be tapered in the same direction.

In this embodiment, an optical fiber OF having a stripped portion SP can be received through the first opening 464, the formation passageway 428 and the second opening 466 of the formation member 424 and received through the first opening 463, the spreader passageway 458 and the second opening 465 of the spreader member 456. In some embodiments, the first portion 460 and the second portion 462 of the formation member 424 can be coupled together, and the first portion 468 and second portion 470 of the spreader member 456 can be coupled together prior to the optical fiber OF being coupled to the recoat apparatus 400. For example, the optical fiber OF can be coupled to one of the fiber holders 450, 452, placed through the formation passageway 428 and the spreader passageway 458 and then coupled to the other of the fiber holders 450, 452. In some embodiments, the optical fiber OF can be coupled to the recoat apparatus 400 (e.g., with the fiber holders 450, 452) and then the first portion 460 and the second portion 462 of the formation member 424 can be coupled together and the first portion 468 and the second portion 470 of the spreader member 456 can be coupled to together such that the formation member 424 and the spreader member 456 each surrounds the optical fiber OF.

Light sources 430 are coupled to both the formation member 424 and the spreader member 456 such that the light sources 430 can move with the carriage 422 relative to the optical fiber OF. As described above for previous embodiments, the light sources 430 can expose the uncured recoat material that is disposed on the optical fiber OF to, for example, UV light to cure the uncured recoat material URM as described in more detail below.

The formation member 424 and the spreader member 456 can each be formed with the same materials as described above for previous embodiments of the formation members, and can be selectively coupled to, for example, a base member (not shown) of the recoat apparatus 400. For example, although one formation member 424 and one spreader member 456 are illustrated, the recoat apparatus 400 can include multiple selectable and interchangeable formation members 424 and spreader members 456 each having a different cross-sectional size and/or shape as described above for previous embodiments. In some embodiments, the formation passageway 428 and the spreader passageway 458 can each be defined by a respective insert that can be coupled to the formation member 424 and the spreader member 456, respectively. In some embodiments, the formation passageway 428 and the spreader passageway 458 can be defined by the formation member 424 and the spreader member 456, respectively, without an insert.

In use, the carriage 422 can move in a first direction A substantially parallel to a centerline CL of the optical fiber OF, and a second direction C substantially parallel to the centerline CL of the optical fiber OF and in an opposite direction of the direction A. In this embodiment, the direction A and the direction C are substantially parallel to a support surface on which the recoat apparatus 400 is disposed (e.g., a floor surface or table surface). In alternative embodiments, the direction A and the direction C can be perpendicular to a support surface on which the recoat apparatus 400 is disposed. The carriage 422 can move or translate in the direction A substantially parallel to the centerline CL of the optical fiber OF to dispense an uncured recoat material URM into the formation passageway 428 and onto the stripped portion SP of the optical fiber OF. For example, as described above, the nozzle 426 is defined by the formation member 424, which is coupled to the carriage 422 such that the nozzle 426 can move with the carriage 422 relative to the optical fiber OF. As shown in FIGS. 8 and 10, during the recoat process, as the carriage 422 is moved in the direction A along a length of the optical fiber OF, an uncured recoat material URM can be supplied to the nozzle 426 from a material distribution system 434 via an inlet line 441, and the nozzle 426 can dispense the uncured recoat material URM into the formation passageway 428. The formation member 424 can confine or bound the uncured recoat material URM within the formation passageway 428 except at or near the first opening 464 and the second opening 466. Thus, the dispensed uncured recoat material URM can be distributed along a length of the stripped portion SP of the optical fiber OF as the carriage 422 is moved in the direction A.

The tapered portion of the formation passageway 428 can define at least in part the outer cross-sectional shape and/or size (e.g., diameter, width, height) of the uncured recoat material URM on the optical fiber OF. In some embodiments, the uncured recoat material URM can be relatively thick and viscous and at least a portion of the dispensed uncured recoat material URM can adhere to the stripped portion SP of the optical fiber OF by surface tension. The flow of the uncured recoat material URM can be controlled with a controller (not shown) coupled to the nozzle 426 as described above for previous embodiments.

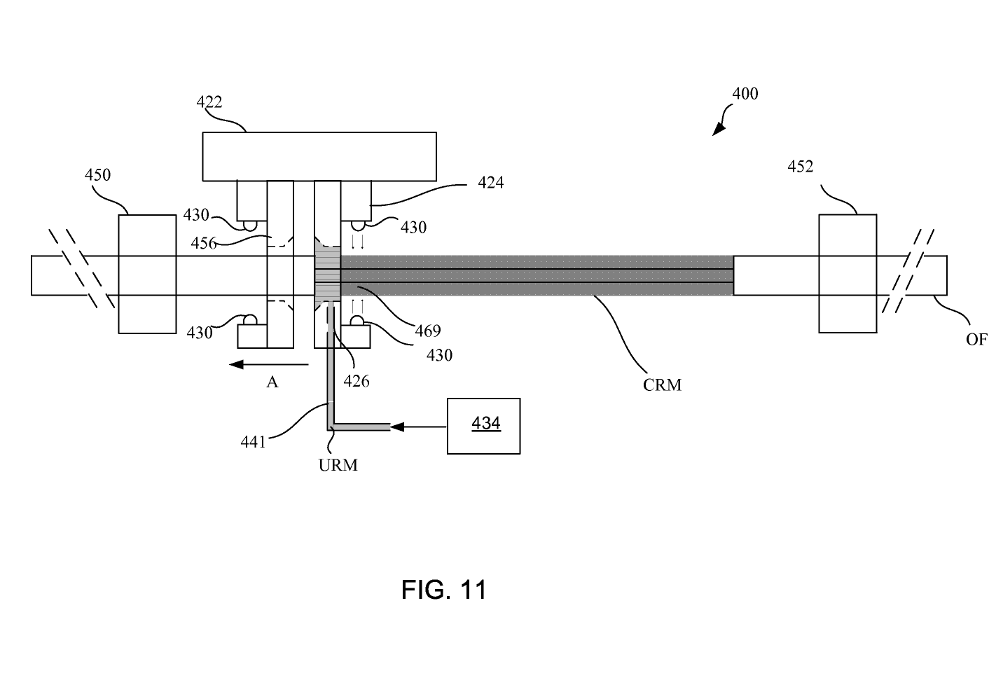

As the carriage 422 is moved in the direction A, the light sources 430 disposed on the formation member 428 can expose the uncured recoat material URM disposed on the stripped portion SP of the optical fiber OF within a curing zone 469 to, for example, UV light, as shown in FIGS. 10 and 11 to produce cured recoat material (CRM). After the carriage 422 has reached an end of its travel along a desired length of the optical fiber OF, the carriage 422 can be moved in the direction C such that the spreader member 456 can spread the uncured or partially uncured recoat material URM along the optical fiber OF. For example, in some cases, although most of the uncured recoat material URM disposed onto the stripped region SP of the optical fiber can be cured by the light sources 430 on the formation member 424, a small portion of uncured recoat material may be present on the stripped portion SP of the optical fiber OF within the formation passageway 428 where the uncured recoat material URM is not fully exposed to the light sources 430 on the formation member 424. Thus, the spreader member 456 can be used to spread this portion of uncured recoat material URM along the optical fiber OF such that this portion of uncured recoat material URM can be cured using the light sources 430 disposed on the spreader member 456. The tapered portion of the spreader passageway 458 can define at least in part the outer cross-sectional shape and/or size (e.g., diameter, width, height) of the uncured recoat material on the optical fiber OF as the spreader member 456 spreads the recoat material.

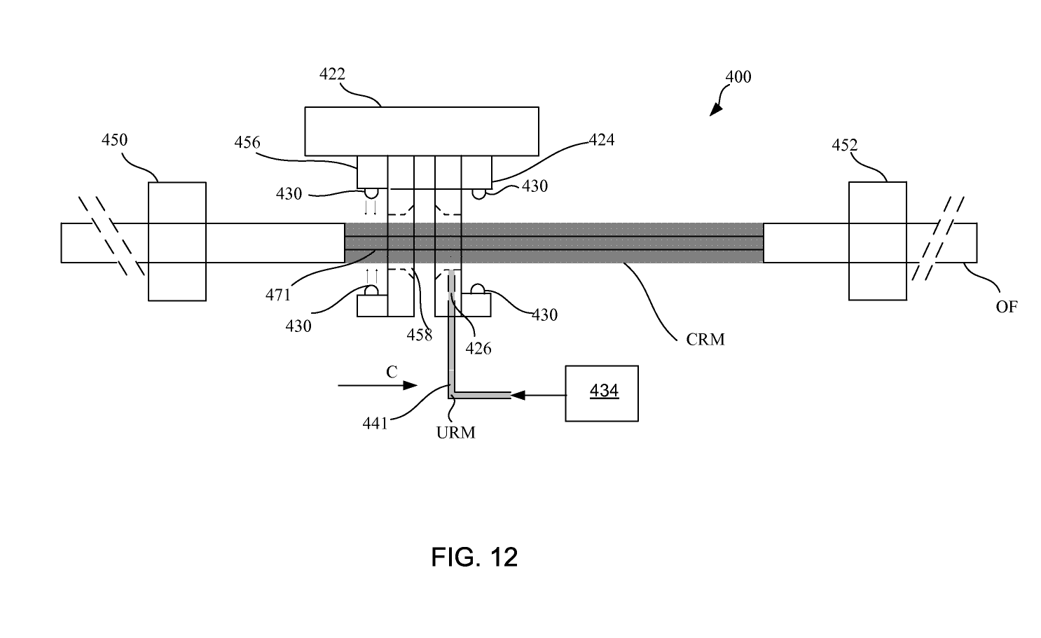

As the carriage 422 is moved in the direction C, the light sources 430 disposed on the spreader member 456 can expose the uncured recoat material (or partially uncured recoat material) to UV light within a curing zone 471 to cure any remaining uncured recoat material, as shown in FIG. 12. As shown in FIG. 12, the stripped portion SP of the optical fiber OF is now covered or coated with cured recoat material CRM, and the optical fiber OF can be removed from the recoat apparatus 400. As in the previous embodiments, in some cases, uncured recoat material can remain in the nozzle 426 and can be used to recoat another optical fiber.

In some embodiments, during the curing process, the recoat material may shrink, reducing its outer size (e.g., diameter, width, height), as shown, for example, in FIG. 10. For example, if the formation passageway 428 has a diameter of 190 microns, the final diameter of the cured recoat material can be, for example, about 165 microns. Thus, in some embodiments, the outer diameter of the cured recoat material can shrink by about 25 microns during the curing process. In other embodiments, the amount of shrinkage can be more or less, depending, for example, on factors such as, the size (e.g., diameter, width, height) of the formation passageway 428, the type of recoat material used, and/or the curing conditions. Because of the shrinkage of the recoat material during the curing process, the size (e.g., diameter, width, height) of the cured recoat material can be less than the size (e.g., diameter, width, height) of the recoat material when uncured and disposed within the formation passageway 428 or the spreader passageway 458. As such, the recoated optical fiber can fit through the formation passageway 428 and the spreader passageway 458 to, for example, remove the optical fiber from the recoat apparatus 400.

In some embodiments it may be desirable to apply one or more additional layers of recoat material over the previously recoated optical fiber. Each subsequent layer of uncured recoat material can be dispensed and cured in a manner as described above. The total thickness of the recoated optical fiber can increase with the addition of each subsequent layer of recoat material. Thus, the single formation member 424 (having a single sized (e.g., diameter) formation passageway 428) can produce different sizes (e.g., diameters) of recoated fiber.

Although the direction A was illustrated as the dispensing direction and the direction C was illustrated as the spreading direction, it should be understood that in alternative embodiments, the recoat apparatus can be configured such that the directions can be reversed. In addition, the amount or distance of travel of the carriage 422 can be varied. For example, the carriage 422 can move a distance equal to a length of the stripped portion SP of the optical fiber to be recoated. In some embodiments, the carriage 422 can move a distance longer or shorter than the stripped portion SP of the optical fiber OF.

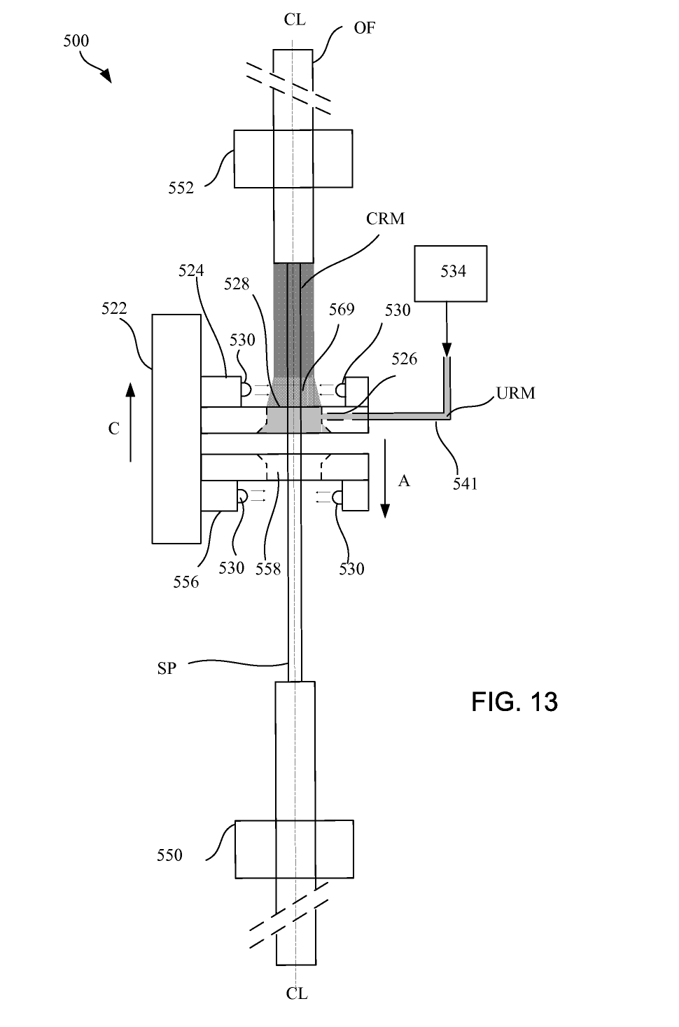

FIG. 13 illustrates an embodiment of a fiber recoat apparatus 500 (also referred to as “recoat apparatus”) that is constructed similar to the recoat apparatus 400. In this embodiment, the recoat apparatus 500 includes, a carriage 522, a formation member 524 defining a formation passageway 528, a nozzle 526, a spreader member 556 defining a spreader passageway 558 and light sources 530 disposed on both the formation member 524 and the spreader member 558. The formation member 524 and the spreader member 556 and their respective components can be formed the same as or similar to, and function the same as or similar to the formation member 424 and the spreader member 456, respectively, described above. Thus, the fiber recoat apparatus 500 can be used to recoat a stripped portion of an optical fiber in the same manner as described above for recoat apparatus 400.

In this embodiment, an optical fiber OF having a stripped portion SP to be recoated can be coupled to the recoat apparatus 500 with a first holder 550 and a second holder 552 as described above for previous embodiments. The optical fiber OF can also be received through the formation passageway 528 and the spreader passageway 558. Thus, in this embodiment, the optical fiber OF can be coupled to the recoat apparatus 500 such that the optical fiber OF is disposed in a direction perpendicular to a support surface (e.g., a floor or table surface) on which the recoat apparatus 500 is placed. In some cases, such an orientation (e.g., perpendicular to the support surface of the recoat apparatus) can provide a more uniform recoat coat thickness around the stripped portion SP of the optical fiber OF because the force of gravity does not distort the uncured recoat material in a direction perpendicular to the centerline CL of the optical fiber OF.

In this embodiment, the carriage 522 can move in a direction A substantially parallel to a centerline CL of the optical fiber OF and substantially perpendicular to the support surface on which the recoat apparatus 500 is disposed, and a direction C opposite to the direction A. In use, the carriage 522 can move in the direction A to dispense an uncured recoat material URM into the formation passageway 528 and onto and substantially surrounding the stripped portion SP of the optical fiber OF as shown in FIG. 13. For example, as described above for recoat apparatus 400, the nozzle 526 is defined by the formation member 524, and the formation member 524 is coupled to the carriage 522 such that the nozzle 526 can move with the carriage 522 relative to the optical fiber OF. An uncured recoat material URM can be supplied to the nozzle 526 from a material distribution system 534 via an inlet line 541, and the nozzle 526 can dispense the uncured recoat material URM into the formation passageway 528. Thus, the dispensed uncured recoat material URM can be distributed along a length of the stripped portion SP of the optical fiber OF as the carriage 522 is moved in the direction A.

As with the previous embodiment, as the carriage 522 is moved in the direction A, the light sources 530 disposed on the formation member 528 can expose the uncured recoat material URM disposed on the stripped portion SP of the optical fiber OF within a curing zone 569 to, for example, UV light, as shown in FIG. 13. After the dispensing process is complete, the carriage 522 can be moved in the direction C such that the spreader member 556 can spread any remaining uncured or partially uncured recoat material URM along the optical fiber OF and cure the remaining uncured recoat material with the light sources 530 disposed on the spreader member 556.

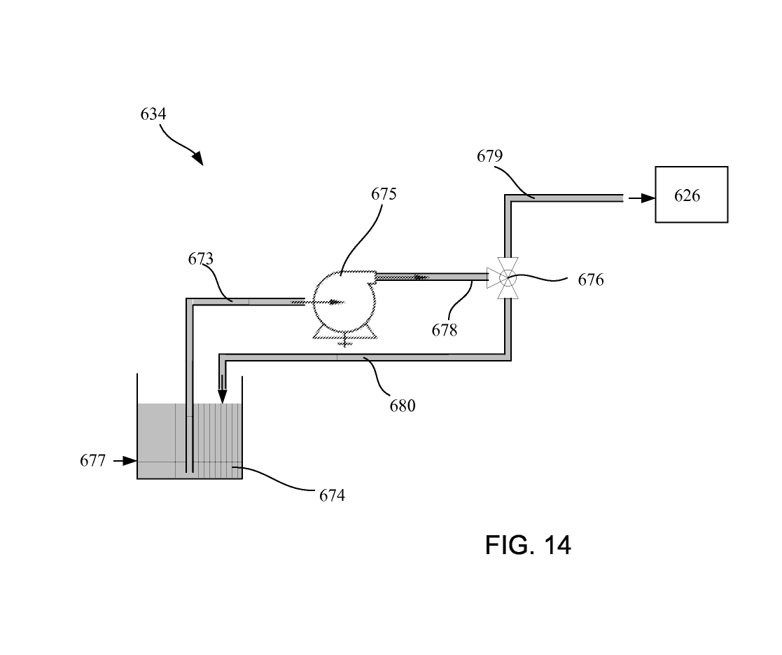

Each of the fiber recoat apparatus described herein can be coupled to or include a recoat material distribution system to deliver uncured recoat material to the nozzle. FIG. 14 is a schematic illustration of an embodiment of one material distribution system that can be used to deliver the uncured recoat material to a nozzle of a fiber recoat apparatus described herein. A recoat material distribution system 634 can include a recoat material reservoir 674 that can be manually or automatically filled with uncured recoat material. A pump 675 can be used to draw uncured recoat material from the recoat material reservoir 674, into a first inlet line 673 coupled between the reservoir 674 and the pump 675, and to a second inlet line 678.

A two-way valve 676 can be disposed between the pump 675 and a nozzle 626 of a recoat apparatus and used to selectively direct the uncured recoat material into either the nozzle 626 via a dispensing line 679 or back into the recoat material reservoir 674 via a return line 680. In some embodiments, the two-way valve 676 can upon initial actuation of the pump 675 after the reservoir 674 has been filled, direct the initial flow of recoat material back to the recoat material reservoir 674. For example, to reduce or eliminate bubbles within the initial flow of recoat material, the flow of material can be directed back to the recoat material reservoir 674 to prevent or at least reduce the bubbles from reaching the nozzle 626. Once a substantially steady, bubble free flow has been established, the two-way valve 676 can be actuated to direct the recoat material to the nozzle 626. The pump 675 can be stopped at this point, and the material distribution system 634 can be in a ready position to supply recoat material to the recoat apparatus to recoat a stripped portion of an optical fiber as described above.

During a recoat process to recoat the stripped portion of the optical fiber, the pump 675 can be energized or actuated to cause the recoat material to flow into the nozzle 626. Substantially simultaneously with the recoat material emerging from the nozzle 626, the nozzle 626 can begin to translate (e.g., via a carriage as described above) along a length of the stripped portion of the optical fiber. As previously described, the flow rate can be controlled with a controller (not shown in FIG. 13) coupled to the nozzle 626 such that the recoat material is dispensed at a desired rate to maintain a desired and/or a substantially uniform recoat thickness. For example, in some embodiments, the flow rate can be in the range of 0.1 to 4.0 micro-liters per second. In some embodiments, the same controller that controls the flow rate of the recoat material can also control the pump 675. In some embodiments, a separate controller can be used to control the pump 675.

After the nozzle 626 reaches the end of the stripped portion of the optical fiber, the pump 675 can be deactivated to stop the flow of recoat material through the nozzle 626. This cycle can be repeated for subsequent optical fibers until a low fluid level is detected by a low level sensor 677 disposed in the recoat material reservoir 674. The sensor 677, for example, can alert the operator to manually refill the recoat material reservoir 674. The material distribution system 634 can then be purged of potential bubbles as previously described and once again can be ready to recoat optical fibers.

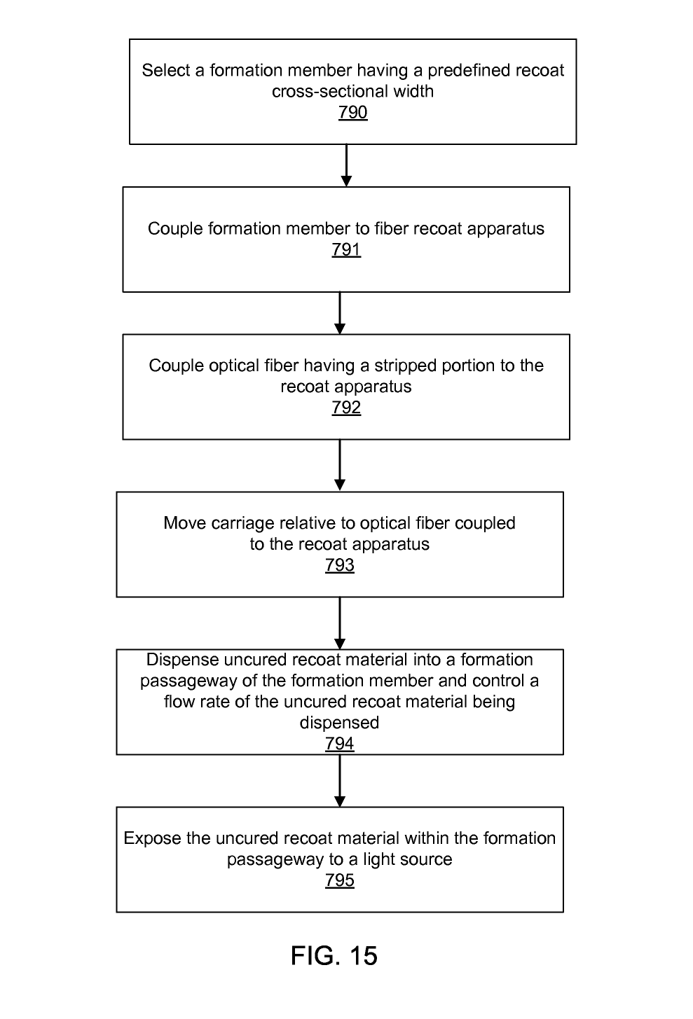

FIG. 15 is a flowchart illustrating a method of recoating an optical fiber according to an embodiment. The method includes at 790, selecting a formation member having a predefined recoat cross-sectional width. For example, a recoat apparatus as described herein can be configured to accommodate multiple different formation members having a formation passageway defining multiple different cross-sectional sizes and/or shapes. At 791, the selected formation member can be coupled to the recoat apparatus. At 792, an optical fiber having a stripped portion to be recoated can be coupled to the recoat apparatus. At 793, a carriage of the recoat apparatus can be moved relative to the optical fiber coupled to the recoat apparatus. At 794, an uncured recoat material can be dispensed into the formation passageway as the carriage is moved such that the dispensed recoat material is distributed onto and surrounds at least a portion of the stripped portion of the optical fiber. For example, as described herein, a nozzle can be coupled to the carriage and configured to dispense a recoat material into the formation passageway of the formation member as the carriage is moved relative to the optical fiber. During the dispensing of the recoat material, a flow rate of the uncured recoat material being dispensed can be controlled such that the stripped region of the optical fiber has a substantially predetermined recoat cross-sectional width. At 795, the uncured recoat material disposed on the stripped portion of the optical fiber can be exposed to a light source to cure the recoat material. For example, as described herein, the recoat apparatus can include one or more light sources that can be used to cure the recoat material. In some embodiments, the light source(s) can be coupled to the carriage such that they can move with the carriage relative to the optical fiber. In some embodiments, the light source(s) can be coupled to a separate light carriage that can be moved into a first position during the recoating process, and into a second position disposed near the optical fiber with recoat material disposed therein.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Where methods described above indicate certain events occurring in certain order, the ordering of certain events can be modified. Additionally, certain of the events can be performed concurrently in a parallel process when possible, as well as performed sequentially as described above. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. An apparatus, comprising:
a formation member defining a passageway configured to receive therein at least a portion of an optical fiber including a stripped portion to be recoated, the passageway defining at least in part a recoat cross-sectional width of the stripped portion of the optical fiber to be recoated; and
a nozzle coupled to the formation member and configured to dispense a recoat material into the passageway when the nozzle is moved relative to the stripped portion of the optical fiber when the stripped portion of the optical fiber is disposed at least partially within the passageway such that the recoat material is dispensed on and surrounds the stripped portion of the optical fiber.

2. The apparatus of claim 1, further comprising:
a carriage coupled to the formation member and the nozzle, the carriage configured to move relative to the optical fiber in a direction substantially parallel to a centerline of the passageway when the optical fiber is at least partially disposed within the passageway and when the recoat material is dispensed by the nozzle such that the recoat material is distributed along a length of the stripped portion of the optical fiber.

3. The apparatus of claim 1, further comprising:
a carriage coupled to the formation member and the nozzle, the carriage configured to move relative to the optical fiber in a first direction substantially parallel to a centerline of the passageway when the optical fiber is at least partially disposed within the passageway and when the recoat material is dispensed such that the recoat material is distributed along a length of the stripped portion of the optical fiber, the carriage further configured to move in a second direction substantially perpendicular to the centerline of the passageway.

4. The apparatus of claim 1, further comprising:
a controller configured to control a flow rate of the recoat material when dispensed into the passageway.

5. The apparatus of claim 1, further comprising:
a carriage coupled to the formation member and configured to move relative to the optical fiber when the optical fiber is at least partially disposed within the passageway; and
at least one light source coupled to the carriage, the at least one light source configured to cure the recoat material.

6. The apparatus of claim 1, further comprising:
a recoat material distribution system coupled to the nozzle and configured to supply an uncured recoat material to be dispensed within the channel.

7. The apparatus of claim 1, further comprising:
a carriage coupled to the formation member and configured to move relative to the optical fiber when the optical fiber is at least partially disposed within the passageway; and
at least one light source coupled to the carriage, the at least one light source configured to cure the recoat material, the formation member being substantially opaque to the at least one light source.

8. The apparatus of claim 1, wherein the passageway is configured to receive the stripped portion of the optical fiber such that as the recoat material is dispensed into the passageway, the formation member bounds a first portion of the recoat material surrounding the optical fiber and does not bound a second portion of the recoat material surrounding the optical fiber after the recoat material has been dispensed into the passageway.

9. The apparatus of claim 1, wherein the formation member is a first formation member, the apparatus further comprising:
a base member; and
a second formation member, the second formation member defining a recoat cross-sectional width that is different than the recoat cross-sectional width of the first formation member, the first formation member and the second formation member being selectively couplable to the base member,
the apparatus having a first configuration in which the first formation member is coupled to the base member and a second configuration in which the second formation member is coupled to the base member.

10. An apparatus, comprising:
a formation member defining a passageway configured to receive at least a portion of a stripped portion of an optical fiber;
a carriage coupled to the formation member and configured to move relative to an optical fiber when the optical fiber is at least partially disposed within the passageway; and
a nozzle coupled to the carriage and configured to dispense an uncured recoat material within the passageway when the carriage is moved relative to the optical fiber such that the uncured recoat material is dispensed onto and surrounds at least a portion of the stripped portion of the optical fiber when disposed within the passageway, the formation member at least in part defining a recoat cross-sectional width of the stripped region of the optical fiber.

11. The apparatus of claim 10, wherein the carriage is configured to move relative to the optical fiber in a first direction, the apparatus further comprising:
a spreader member coupled to the carriage, the spreader member configured to surround a portion of the stripped portion of the optical fiber, the spreader member configured to spread the uncured recoat material along at least a portion of the optical fiber when the carriage is moved relative to the optical fiber in a second direction opposite the first direction, the spreader member at least in part defining a recoat cross-sectional width of the stripped portion of the optical fiber.

12. The apparatus of claim 10, further comprising:
a controller configured to control a flow rate of the recoat material to be dispensed into the passageway of the formation member.

13. The apparatus of claim 10, further comprising:
at least one light source coupled to the carriage, the at least one light source configured to cure the recoat material after being dispensed into the passageway.

14. The apparatus of claim 10, further comprising:
a recoat material distribution system coupled to the formation member and configured to supply an uncured recoat material to be dispensed into the passageway of the formation member.

15. The apparatus of claim 10, wherein the carriage is configured to move relative to the optical fiber in a first direction substantially parallel to a centerline of the passageway, the carriage configured to further move in a second direction substantially perpendicular to the centerline of the passageway.

16. The apparatus of claim 10, wherein the carriage is configured to move in a direction substantially parallel to a support surface on which the apparatus is disposed.

17. The apparatus of claim 10, wherein the carriage is configured to move in a direction substantially perpendicular to a support surface on which the apparatus is disposed.

18. A method, comprising:
moving a nozzle of a recoat apparatus relative to an optical fiber having a stripped portion;
dispensing uncured recoat material into a passageway of the recoat apparatus as the nozzle is moved such that the dispensed recoat material is distributed onto and surrounds at least a portion of the stripped portion of the optical fiber, the dispensing including controlling a flow rate of the uncured recoat material being dispensed such that the stripped region of the optical fiber has a substantially predetermined recoat cross-sectional width; and
exposing the uncured recoat material disposed on the stripped portion of the optical fiber to a light source to cure the recoat material.

19. The method of claim 18, further comprising:
prior to the dispensing, selecting a formation member defining a selected recoat cross-sectional width; and
coupling the selected formation member to at least one of a carriage or a base member of the recoat apparatus.

20. The method of claim 18, further comprising:
prior to the dispensing, selecting a formation member defining the passageway, the passageway having a selected recoat cross-sectional width; and
coupling the selected formation member to at least one of a carriage or a base member of the recoat apparatus.

21. The method of claim 18, wherein the nozzle moves relative to the optical fiber in a first direction, the recoat apparatus includes a spreader member, the method further comprising:
spreading with the spreader member at least a portion of the uncured recoat material along the optical fiber when the spreader member is moved relative to the optical fiber in a second direction, the second direction being opposite the first direction.

22. The method of claim 18, wherein the passageway is defined by a formation member of the recoat apparatus, the dispensing the uncured recoat material includes dispensing the uncured recoat material into the passageway such that as the recoat material is dispensed into the passageway, the formation member bounds a first portion of the recoat material surrounding the optical fiber and does not bound a second portion of the recoat material surrounding the optical fiber.
